(19) United States
(12) Patent Application Publication
(10) Pub. No.: US 2012/0281095 A1
(43) Pub. Date: Nov. 8, 2012

(54) ENTERPRISE MANAGEMENT SYSTEM AND AUDITING METHOD EMPLOYED THEREBY

(75) Inventors: Peter Trenciansky, Georgetown (CA); Peter L. Murdoch, Toronto (CA)

(73) Assignee: SENTRY TECHNOLOGY CORPORATION, Ronkonkoma, NY (US)

(21) Appl. No.: 13/512,412

(22) PCT Filed: Nov. 29, 2010
(86) PCT No.: PCT/CA2010/001894

§ 371 Date: Jul. 20, 2012

(30) Foreign Application Priority Data
Nov. 27, 2009 (US) 61264771

(51) Int. Cl. H04N 7/18

(52) U.S. Cl. 348/159; 348/143; 348/E07.085

(57) ABSTRACT

An auditing method comprises controlling at least one camera device at least at one facility to cause the at least one camera to acquire at least one image of a designated region within the at least one facility; at a remote location, comparing the acquired at least one image of the designated region to a desired standard; and completing an audit report based on the results of the comparing.

### CROSS-REFERENCE TO RELATED APPLICATIONS

This application claims the benefit of U.S. Provisional Application No. 61/264,771 filed on Nov. 27, 2009, the content of which is incorporated herein by reference in its entirety.

### FIELD OF THE INVENTION

The subject invention relates to an enterprise management system and to an auditing method employed thereby.

### BACKGROUND OF THE INVENTION

Camera-based or video surveillance systems are known in the art and a number of formats exist. For example, closed-circuit television (CCTV) technology is widely used and is an important element of security systems for industrial and residential premises. CCTV systems often comprise a combination of simple fixed lens cameras, adjustable pan/tilt/zoom (PTZ) cameras and/or moving track cameras. Access to and control of these cameras may be local or remote via the Internet.

The advantage that CCTV technology brings to industry and government is that security guards and security management personnel can oversee large areas and distributed facilities from a central location, thereby saving time and money. Using remote and/or centralized viewing, security can be provided for multiple extended facilities more cheaply, rapidly and often more effectively than using “boots on the ground”. In addition, a visual record is captured by CCTV systems and is available for review at later times.

First generation CCTV systems employed cameras that covered a specified area and sent analog signals back to a central location. As CCTV technology advanced, complexity of CCTV systems grew. In particular, CCTV systems transitioned to digital video and control signals, recording capabilities were added, traveling cameras became available and control of remote cameras became more common. Today, CCTV systems for enterprises or organizations that are distributed over a large geography, employ camera systems to monitor activities in a wide variety of facilities such as for example, manufacturing centers, distribution centers, retail outlets etc.

Although increasing the complexity of CCTV systems has had numerous benefits, the increased complexity of CCTV systems has caused problems. In particular, difficulties in managing the capabilities of the numerous cameras with numerous standard and proprietary communication and video encoding protocols of the CCTV systems have been encountered. Also, as more people request access to CCTV system information and request at least some control over the CCTV system cameras, CCTV systems have been prone to delays and conflicts resulting in reduced effectiveness of the CCTV systems. In addition, because the investment in CCTV systems can be significant in terms of money and resources, using CCTV systems purely for the purposes of safety and security undervalues the investment by not taking advantage of the full potential of CCTV systems.

Not surprising, advances in the enterprise management field have been made. For example, U.S. Pat. No. 7,567,844 to Thomas et al. discloses a building management system for one or more buildings, having a processor and a display for showing a model of a building being managed. The model may be shown as a three dimensional depiction or rendition, or a virtual building. A database may provide information regarding sensors, actuators and other items which may be viewed in conjunction with the displayed model. Information regarding the location and status of the sensors, control devices, and the like, which may be points of interest, may be mapped on the virtual depiction or model of the building. A user or operator may thus move through the building and view and affect rooms, sensing and control devices, and other items, including quick navigation to points of interest, in virtual reality. A recorder and play mechanism may be a significant portion of the system for recording structures, parameters, environment, events and other information of the system.

To-date, video surveillance systems such as CCTV systems and enterprise management systems have not reached their potential and as a result, improvements are desired. It is therefore an object of the subject application to provide a novel enterprise management system and a novel auditing method employed thereby.

### SUMMARY OF THE INVENTION

Accordingly, in one aspect there is provided an auditing method comprising controlling at least one camera device at least at one facility to cause the at least one camera to acquire at least one image of a designated region within the at least one facility, at a remote location, comparing the acquired at least one image of the designated region to a desired standard and completing an audit report based on the results of the comparing.

In one embodiment, during the comparing, the at least one image is compared to at least one reference image that represents for example the desired appearance of a product display. The controlling, comparing and completing may be performed by an auditor who is a member of an enterprise embodying the facility or who is external to the enterprise.

The comparing may be performed manually, at least partially by feature recognition software, or fully by feature recognition software. The completing may comprise completing an electronic questionnaire.

According to another aspect there is provided an auditing method comprising receiving electronic audit requests from internal and/or external users of a multi-facility enterprise, aggregating audit requests that relate to common facilities into individual audits, assigning electronically each of said audits to one or more individuals of an audit group specified for said audit and assigning viewing access rights to the one or more individuals of the audit group, the viewing access rights determining when the one or more individuals are able to access video feeds from camera devices in the facilities to complete the audits.

According to yet another aspect there is provided an auditing method comprising using a video surveillance system at one or more facilities to capture images of one or more product displays, and comparing the captured images with reference material to evaluate product display compliance.

According to yet another aspect there is provided an apparatus configured to establish communications between at least one client and a video surveillance system at one or more facilities, said apparatus further configured to signal a video surveillance system to capture images of one or more product displays and provide the captured images to the at least one client for comparison with reference material to evaluate product display compliance.

According to still yet another aspect there is provided a method comprising providing multiple users with access to at least one surveillance system at one or more facilities to allow said users to view video captured by the at least one surveillance system and to control video equipment thereof, and controlling access of said users so that users performing priority tasks are given access to the at least one surveillance system over other users.

According to still yet another aspect there is provided an apparatus configured to establish communications between a plurality of clients and at least one surveillance system at one or more target facilities to enable clients performing tasks to view video and control video equipment of said at least one surveillance system, said apparatus being further configured to assign priority rights thereby to ensure clients performing higher priority tasks have preference over clients performing lower priority tasks.

According to still yet another aspect there is provided a non-transitory computer readable medium embodying a computer program, said computer program comprising program code for causing a camera device of a video surveillance system to capture one or more images of a product display; and program code for comparing each captured image with reference material to evaluate product display compliance.

According to still yet another aspect there is provided a video surveillance controller configured to allow cameras linked to user access rights to be selected; represent the locations of the cameras on a displayed floor plan map, areas of the floor plan being linked to preprogrammed camera views; and provide access to camera views in response to selection of the camera representations on the floor map.

The floor plan may display individual cameras, their positions relative to the floor plan and their operational status including for example availability for use and camera angles selected. The floor plan may form a level of a multi-level drill-down map, with each level displaying a broader geography encompassing the geographical location of the floor plan.

### BRIEF DESCRIPTION OF THE DRAWINGS

Embodiments will now be described more fully with reference to the accompanying drawings in which:

FIG. 1 is a schematic block diagram of an enterprise management system;

FIG. 2 is a block diagram showing modules of the enterprise management system of FIG. 1;

FIGS. 3a to 3d show a header and map view web pages of an enterprise management web application run by the enterprise management system of FIG. 1;

FIG. 4 shows a video camera control panel forming part of the map view web page of FIG. 3d;

FIG. 5a shows another view of the video camera control panel of FIG. 4;

FIG. 5b shows yet another view of the video camera control panel of FIG. 4;

FIG. 6 shows a local chat panel forming part of the map view web page of FIG. 3d;

FIG. 7 shows yet another view of the video camera control panel of FIG. 4 together with the local chat panel of FIG. 6;

FIG. 8 shows the header and a video camera view web page of the enterprise management web application;

FIG. 9 shows a video camera view panel forming part of the video camera view web page of FIG. 8;

FIG. 10 shows yet another view of the video camera control panel of FIG. 4 presented in the video camera view web page;

FIG. 11 shows still yet another view of the video camera control panel of FIG. 4 presented in the video camera view web page;

FIG. 12 shows the header and an archive view web page of the enterprise management web application;

FIG. 13 shows a user setting window of the enterprise management web application;

FIG. 14 shows the header and an audit request view web page of the enterprise management web application; and

FIGS. 15a to 15c show the header and audit view web pages of the enterprise management web application.

### DETAILED DESCRIPTION OF THE EMBODIMENTS

In the following, an enterprise management system to facilitate management of business operations and procedure compliance, audits, employee training and safety and security control within one or more enterprises is described. The enterprise management system interacts with the video surveillance system(s) of each enterprise that is managed by the enterprise management system and allows users of each enterprise to view authorized live video feeds and previously recorded video for operation and procedure compliance, audit, employee training and safety and security control purposes. In a typical environment, the enterprise management system manages a plurality of enterprises. For ease of discussion and illustration however, an enterprise management system managing a single enterprise will now be described with reference to the Figures.

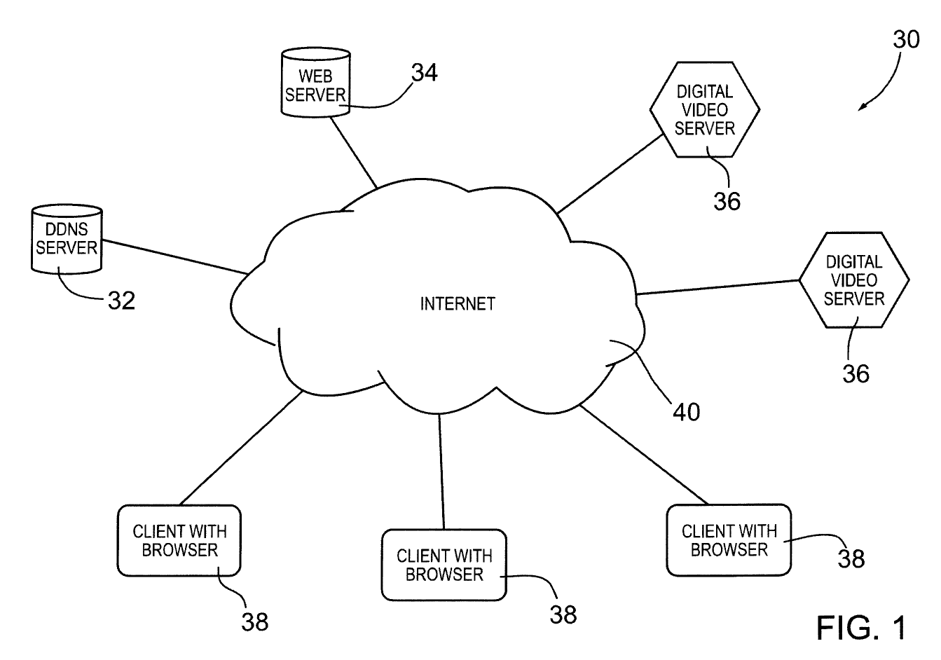

Turning now to FIG. 1, an enterprise management system is shown and is generally identified by reference numeral 30. As can be seen, enterprise management system 30 comprises a dynamic domain name server (DDNS) 32, at least one web server 34, a plurality of digital video servers 36 and a plurality of clients 38. The dynamic domain name server 32, web server 34, digital video servers 36 and clients 38 communicate over the Internet 40.

The dynamic domain name server 32 tracks and stores the Internet Protocol (IP) addresses assigned to the digital video servers 36 and the clients 38 for each Internet session. The web server 34 hosts an enterprise management web application and at least one associated database. Each digital video server 36 communicates with the control center of an associated closed-circuit television (CCTV) system and provides a centralized access point to all of the video feeds and all of the video equipment of the associated CCTV system.

The CCTV systems are located at the various facilities of the enterprise to be monitored. For global enterprises, CCTV systems may be located at facilities throughout the world. For mid-size enterprises, CCTV systems may be located at facilities in fewer countries. For small enterprises, CCTV systems may be located at facilities in a single country. Regardless of the size of the enterprise, the enterprise management system 30 allows the CCTV system at each facility of the enterprise to be monitored and controlled.

Each CCTV system may comprise one or more different types of video equipment. The size and importance of the facility in which the CCTV system is located typically determines the number and type of video equipment employed. For example, in larger important facilities, the CCTV system may employ a combination of fixed lens video cameras, pan/tilt/zoom (PTZ) video cameras, and moving track video cameras such as those sold by Sentry Technology Corporation of New York, U.S.A., assignee of the subject application.

Each client 38 comprises a suitable computing device that runs a standard compliant web browser. For example, one or more of the clients 38 may comprise stand-alone computers (e.g. personal computers, laptop computers, notebook computers etc.) and one or more of the clients 38 may comprise handheld devices (e.g. cellular telephones, personal digital assistants (PDAs) etc.) that are able to establish a suitable wired or wireless Internet connection with the web server 34. Alternatively, one or more of the clients 38 may comprise a computing device forming part of a local area network (LAN) or wide area network (WAN) that is able to establish a suitable wired or wireless Internet connection with the web server 34 via a network server. Through the compliant web browser, users are able to connect to the web server 34 to retrieve active web pages of the enterprise management web application hosted by the web server 34 and load components (e.g. ActiveX, Java components etc.) of the enterprise management web application that allow the clients 38 to communicate with the CCTV systems of interest over an Internet connection indirectly through the digital video servers 36. Alternatively, users may connect to the web server 34 to retrieve active web pages of the enterprise management web application that allow the clients 38 to communicate directly with the CCTV systems over an Internet connection thereby bypassing the digital video servers 36 and obviating the need to use ActiveX or similar components during communications with the CCTV systems. Regardless of the type of Internet connection between clients 38 and CCTV systems, once Internet connections between clients 38 and CCTV systems have been established, users can issue commands allowing the users to retrieve and view one or more selected video feeds from the CCTV systems and/or to control video equipment of the CCTV systems as will be described.

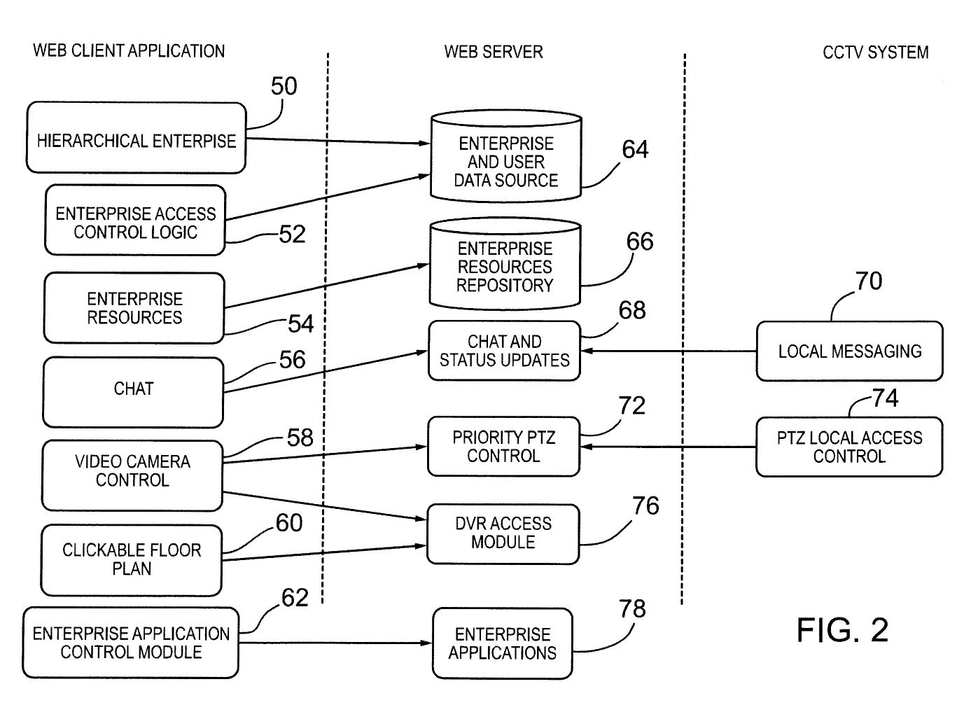

Turning now to FIG. 2, modules of the enterprise management system 30 are shown. As can be seen, the enterprise management web application comprises a hierarchical enterprise module 50, an enterprise access control logic module 52, an enterprise resources module 54, a chat module 56, a video camera control module 58, an enterprise map module 60 and an enterprise application control module 62. The hierarchical enterprise module 50 and enterprise access control logic module 52 communicate with the web server 34 and access enterprise and user data 64 stored in the web server database. The enterprise resources module 54 also communicates with the web server 34 and accesses an enterprise resources repository 66 stored in the web server database. The chat module 56 provides a messaging function represented by blocks 68 and 70 to permit users of clients 38 to conduct messaging via the web server 34. The video camera control module 58 and the enterprise map module 60 permit users of clients 38 to select a target CCTV system and communicate with the target CCTV system in order to view video feeds and control video equipment of the target CCTV system as represented by blocks 72, 74 and 76. In this embodiment, the enterprise map module 60 provides a user friendly drill-down interface that allows a target CCTV system within the enterprise to be selected. The enterprise application control module 62 communicates with the web server 34 and accesses enterprise applications 78 running on the web server 34. In this embodiment, the enterprise application control module 62 accesses enterprise audit, task and training applications 78.

In this embodiment, the enterprise management web application is written in a combination of languages, namely PHP5 on the server side and Java and JavaScript on the client side. The servers use suitable protocols that encapsulate command streams and H.264, MPEG-4 or similar video streams.

During set-up of the enterprise management system 30, an account for the enterprise in the enterprise management web application is created and stored in the web server database. In this embodiment, the enterprise is a retail enterprise comprising retail establishments (facilities) at a plurality of different geographical locations. As will be appreciated, as the enterprise is a retail enterprise, the CCTV systems in the various retail establishments are not only extremely useful for safety and security purposes, but are also very useful for product promotion, product display and inventory stocking evaluation purposes. During the account setup process, the hierarchical enterprise module 50 presents drop-down menus to the enterprise system administrator allowing the system administrator to specify the parent business unit of the retail enterprise and each business unit of the retail enterprise that is below the parent business unit. The enterprise information entered by the system administrator is stored in the web server database. In this manner the complete corporate tree or organizational chart of the retail enterprise is specified and stored.

Each business unit may also be designated as a member of one or more business unit classes. Each business unit class has one or more attributes associated therewith that determine the criteria that each business unit must fulfill in order to qualify for membership of that business unit class. For example, the business unit classes may allow business units to be classified based on hours of operation (e.g. stores that are open 24 hours), inclusion of specific departments (e.g. stores that include automotive departments) etc. Classifying business units in this manner allows users to focus searches for target CCTV systems.

An account for each user who is permitted access to the enterprise management web application is created and maintained by the enterprise access control logic module 52 and is stored in the web server database. The users who are permitted access to the enterprise management web application typically comprise internal employees of the retail enterprise whose roles mandate access to the enterprise management web application as well as authorized external third parties such as for example auditors and clients as will be described.

Each user account specifies the login name and password assigned to the associated user as well as the access level rating assigned to that user. For internal users, the access level rating assigned to the user is a function of the user's position within the retail enterprise and mirrors the user's responsibilities in terms of the business unit to which the user belongs, the geographical location of the user and the user's job function within the retail enterprise. For example, if the user is granted access to the parent business unit of the retail enterprise, the user will typically have access to specified information stored in the enterprise management system 30 associated with the parent business unit as well as all information stored in the enterprise management system 30 associated with all business units in the corporate tree that are below the parent business unit. If the user is granted access to a business unit that is below the parent business unit, the user will typically have access to specified information stored in the enterprise management system 30 associated with the business unit to which access has been granted as well as all information stored in the enterprise management system 30 associated with all business units in the corporate tree that are below the business unit to which access has been granted. For external users, the access level rating ensures the external users are only permitted access to information that is relevant to their role.

Each user is also assigned to a group. For internal users, the group is typically based on the user's geographical location and job function. For external users, the group is typically based on role. Each group has attributes associated therewith that are assigned to the individual users of the group. In this embodiment, the attributes comprise video camera priority levels, video camera access restrictions and functional access restrictions. The video camera priority levels allow users to lock video cameras so that other users with lower assigned video camera priority levels are unable to interrupt control of locked video cameras. Video camera access restrictions establish time windows in which control of video cameras is permitted. For example, security personnel in a given retail establishment or warehouse of a business unit are typically assigned the highest video camera priority level for that facility so that the security personnel always have access to the video cameras in that facility. Other users depending on job function may have higher video camera priority levels at certain times of the day as compared to other times of the day. Some users, such as for example external auditors, may only have access to video cameras in the facility at certain times of the day and have no access to video cameras in the facility at other times of the day. Typically, auditors are provided with access to video cameras at times that are not likely to conflict with security functions and/or other higher priority tasks. Auditors are also typically given a fixed time to complete audits. The functional access restrictions permit the users of groups to use particular functions. For example, a functional access restriction may permit users of one or more selected groups to create audits while inhibiting users of other groups from creating audits.

As mentioned above, the enterprise resource module 54 monitors and tracks the IP addresses assigned to the digital video servers 36 and associated CCTV systems and the IP addresses assigned to the clients 38, and stores the IP addresses in the web server database. In this manner, changes in assigned IP addresses made by Internet Service Providers (ISPs) are tracked thereby to ensure continuity of communications.

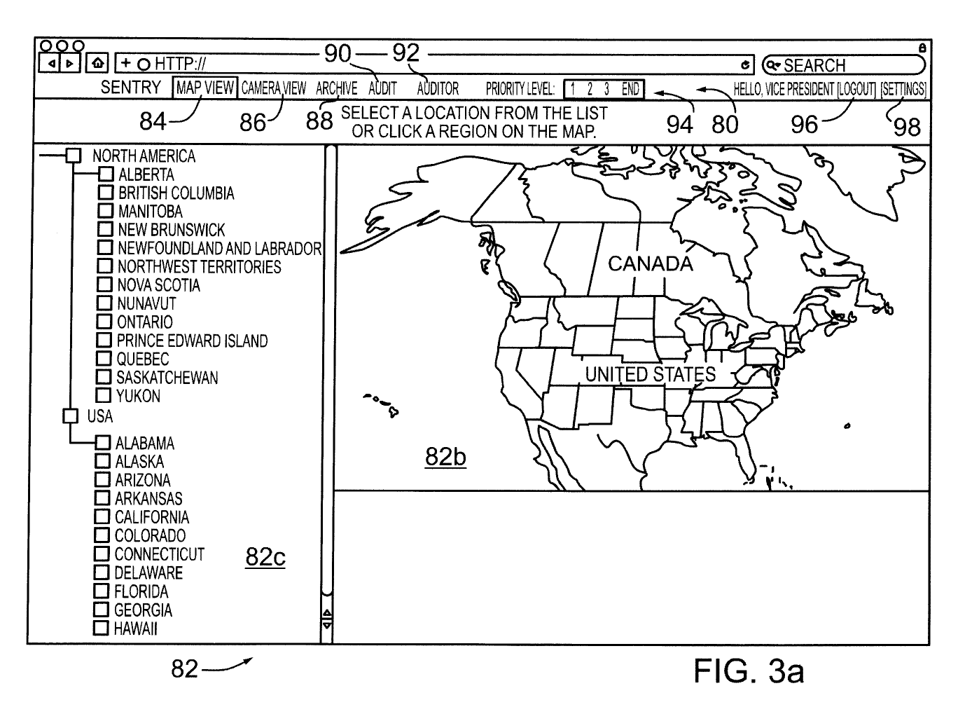

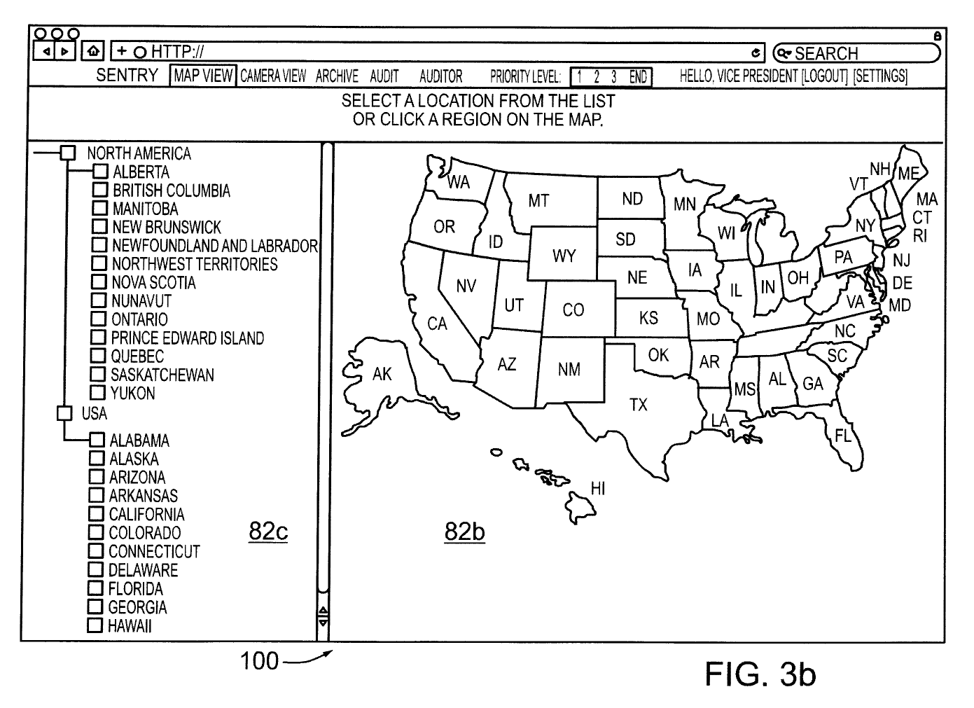

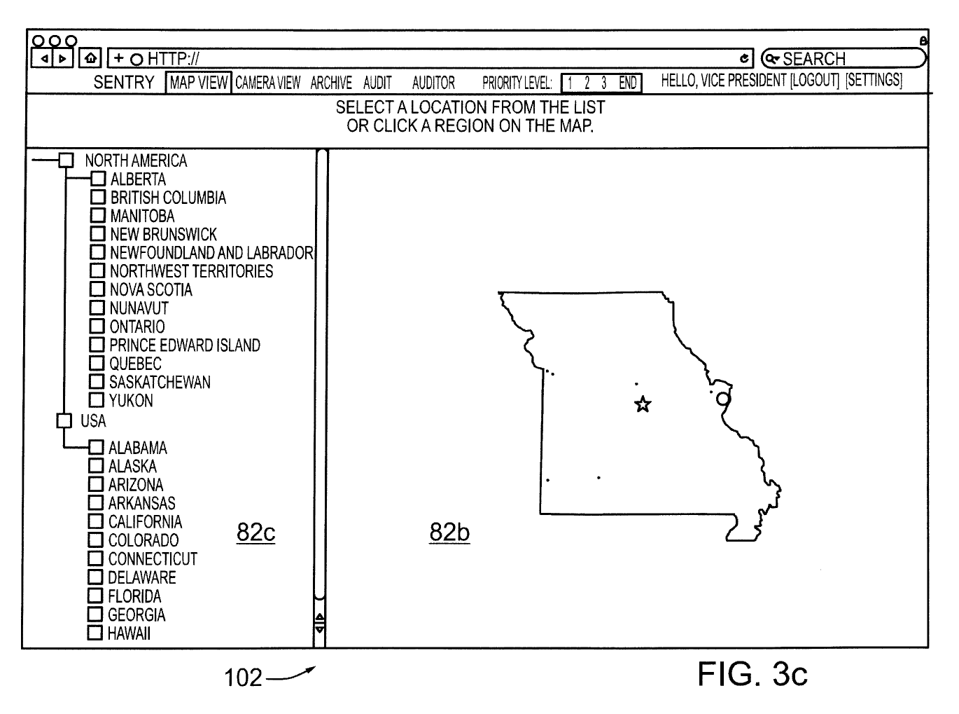

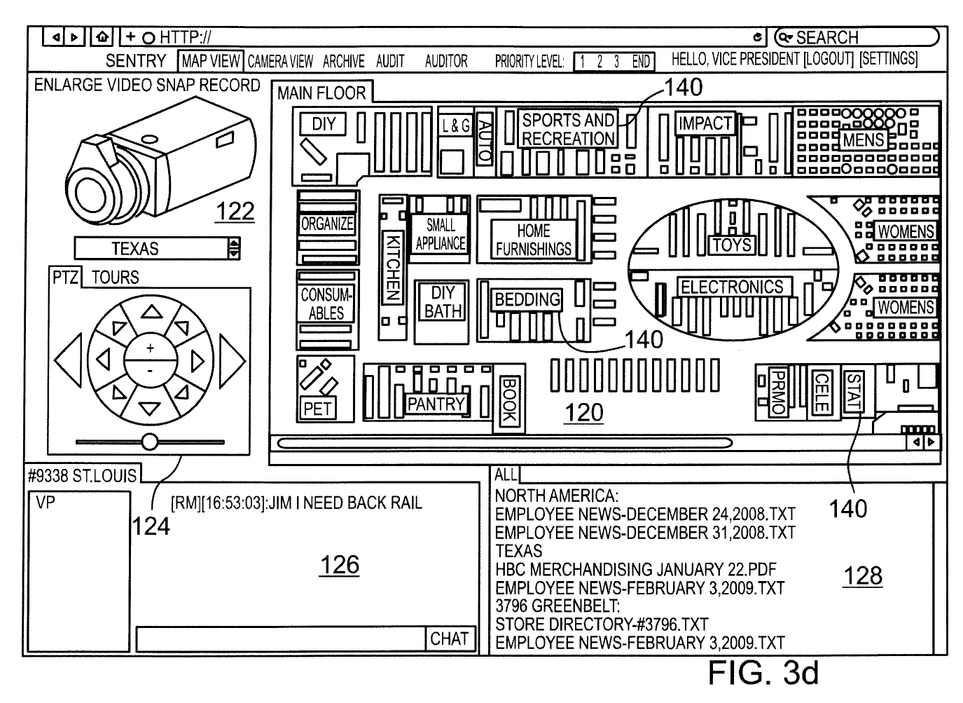

When a user of a client 38 establishes an Internet connection with the web server 34 in order to access the enterprise management web application, the enterprise access control logic 52 presents the user with a login screen that prompts the user to enter their assigned login name and password. In response to entered login name and password information, the enterprise access control logic 52 communicates with the enterprise and user data 64 stored in the web server database to verify the user. Once the user has successfully logged into the enterprise management web application, the web server 34 transmits a header 80 and a default map view web page 82 to the client 38 for presentation to the user as shown in FIG. 3a. The header 80 in this embodiment comprises a selectable map view button 84, a selectable video camera view button 86, a selectable archive button 88, a selectable audit button 90, a selectable auditor button 92, selectable priority level and end buttons 94, a selectable logout button 96 and a selectable user settings button 98. The header 80 also identifies the user who has successfully logged into the enterprise management web application, in this example a vice-president. As the default web page presented to the user upon successful login to the enterprise management web application is a map view web page, the selectable map view button 84 is highlighted.

The map view web page 82 is divided into two (2) areas, namely a map panel 82b and a list panel 82c. In the example illustrated, the map panel 82b presents a map of Canada and the United States, representing the countries in which the retail enterprise has facilities (e.g. retail establishments, warehouses etc.). The list panel 82c presents a list of the provinces of Canada and individual states of the United States of America. The map presented in the map panel 82b and the information presented in the list panel 82c is a function of the access level rating assigned to the user so that only information that is accessible to the user is presented. For example, a facility manager logging into the enterprise management web application, may be presented with a map view web page 82 that provides access only to the facility managed by that individual. A regional manager logging into the enterprise management web application may be presented with a map view web page 82 that provides access to all of the facilities within the region managed by that individual. A retail enterprise executive logging into the enterprise management web application may be presented with a map view web page 82 that provides access to all of the facilities within the retail enterprise.

If the user has global enterprise access rights, the map view web page 82 presented to the user provides access to all of the facilities within the retail enterprise. In this case, the user is able to drill down through the map view web page 82 to identify facilities within a selected region, facilities within a selected sub-region of that region and a target facility in that sub-region. Likewise, if the user has regional enterprise access rights, the map view web page 82 presented to the user identifies all of the facilities within a region. In this case, the user is able to drill down through the map view web page 82 to identify facilities within a selected sub-region of the region and then a target facility in that selected sub-region. If the user has sub-regional access rights, the map view web page 82 presented to the user identifies all of the facilities within a sub-region. In this case, the user is able to drill down through the map view page 82 to identify a target facility in the sub-region. If the user only has local facility access rights, the map view web page 82 presented to the user only identifies the target facility to which the user has access rights.

FIG. 3b shows the map view web page 100 that is presented to the user when the user drills down through the map view web page 82 of FIG. 3a and selects the U.S.A. from the map panel 82b. As can be seen, the map of Canada and the U.S.A. that was presented in the map panel 82b is replaced with a map only of the U.S.A. FIG. 3c shows the map view web page 102 that is presented to the user when the user drills down through the map view web page 100 of FIG. 3b and selects the state of Texas. In this case, the map of the U.S.A. in map panel 82b is replaced with a map of Texas on which each target facility is identified. As will be appreciated by those skilled in the art, if a country, province or state in the list panel 82c is selected, the map panel 82b is updated to show the selected country, province or state.

When the user selects a target facility presented on the map view web page 102, the web server 34 establishes an Internet connection between the client 38 and the CCTV system at the target facility either directly or indirectly via the associated digital video server 36. A graphical user interface is then presented to the user that allows the user to select one or more video feeds from the CCTV system at the target facility for viewing and to control video equipment of the CCTV system. During user interaction with the graphical user interface, commands are generated and sent by the web server 34 to the CCTV system over the Internet connection in a well known manner. An exemplary graphical user interface that is presented to a user when an Internet connection with the CCTV system of a target facility is established will now be described.

FIG. 3d shows the web page 110 that is presented when the user drills down through the map view web page 102 and selects a target facility in the state of Texas. In this case, the map panel 82b and the list panel 82c are replaced with a plurality of panels, which in this embodiment comprises a floor plan panel 120, a video camera view panel 122, a video camera control panel 124, a local user chat panel 126 and an all user chat panel 128.

The floor plan panel 120 shows a layout or floor plan of the selected facility and has selectable “hotspots” 140 representing the various video cameras within the selected facility to which the user has access. When a hotspot 140 is selected, a command is sent to the video camera associated with the selected hotspot resulting in the video camera being automatically activated and moved to a preset view. The captured video of that video camera is then streamed to the client 38 and presented in the video camera view panel 122. If the enlarge button 142 of the video camera view panel 122 is selected, the video camera view panel 122 and the floor plan panel 120 swap locations on the map view web page 110 so that the video feed is presented in a larger viewing area. If the video camera associated with the selected hotspot 140 is a fixed lens video camera, the video camera control panel 124 is disabled. If however, the video camera associated with the selected hotspot 140 is a PTZ or moving track video camera, the video camera control panel 124 allows the user to control the video camera.

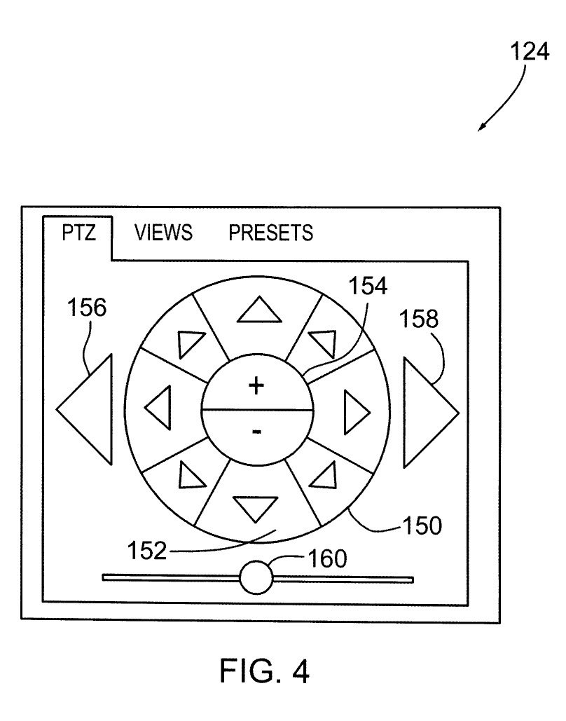

FIG. 4 better illustrates the default view of the video camera control panel 124. As can be seen, in the default view the video camera control panel comprises a compass 150 segmented into a plurality of pan/tilt arrows 152, in this example eight (8) arrows. The arrows 152 surround a central zoom-in/zoom-out (+/−) button 154. Larger arrows 156 and 158 are provided on opposite sides of the compass 150. A slide control 160 is provided below the compass 150. When a pan/tilt arrow 152 of the compass 150 is selected by the user, a corresponding video camera control command is generated and sent to the CCTV system causing the pan/tilt of the appropriate video camera associated with the selected hotspot 140 to change in accordance with the video camera control command. Likewise, when the zoom-in/zoom-out button 154 is selected by the user, either a video camera zoom-in or zoom-out control command is generated and sent to the CCTV system causing the zoom of the video camera associated with the selected hotspot 140 to change in accordance with the video camera control command.

If the video camera associated with the selected hotspot 140 is a PTZ video camera, the larger arrows 156 and 158 are assigned iris control functions if such functions are supported by the PTZ video camera. In this case, when the left arrow 156 is selected by the user, a darken video camera control command is generated and sent to the CCTV system causing the iris of the PTZ video camera associated with the selected hotspot 140 to contract. When the right arrow 158 is selected by the user, a lighten video camera control command is generated and sent to the CCTV system causing the iris of the PTZ video camera associated with the selected hotspot 140 to dialate.

If the video camera associated with the selected hotspot 140 is a moving track video camera, the larger arrows 156 and 158 are assigned video camera move functions. In this case, when the left arrow 156 is selected by the user, a move video camera control command is generated and sent to the CCTV system causing the moving track video camera associated with the selected hotspot 140 to move along the track in one direction and when the right arrow 158 is selected by the user, a move video camera control command is generated and sent to the CCTV system causing the moving track video camera associated with the selected hotspot 140 to move along the track in the opposite direction.

The slide control 160 determines the speed by which video camera control commands are sent to the video camera associated with the selected hotspot 140. Moving the slide control 160 to the left decreases the speed by which video camera control commands are sent to the video camera associated with the selected hotspot 140 thereby to provide the user with finer video camera control. Moving the slide control 160 to the right increases the speed by which video camera control commands are sent to the video camera associated with the selected hotspot 140.

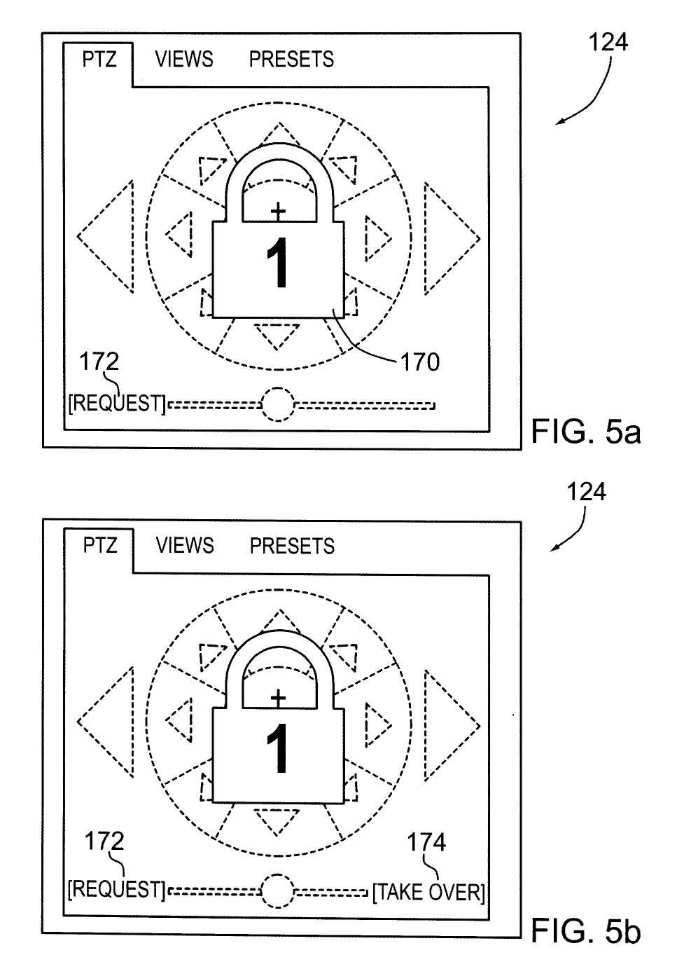

The selectable priority level buttons 94 allow a user to lock a video camera when a priority task is being performed by the user. The priority level button 94 that is selected by the user provides notice to other users of the importance of the priority task being performed by that user, with priority level three (3) being the highest priority and priority level one (1) being the lowest priority. When a priority level button 94 is selected by the user and the user selects a hotspot 140, the video camera associated with the selected hotspot is automatically activated, moved to its preset view and locked. A message is then displayed in the local chat panel 126 identifying the user who locked the video camera and providing notice to other users that the video camera has been locked. When another user selects the hotspot 140 that is associated with the locked video camera, a lock 170 identifying the priority level selected by the user is presented to that user in the video camera control panel 124 as shown in FIGS. 5a and 5b. In this manner, the other user is able to gauge the importance of the priority task being performed by the user who locked the video camera. If the other user has an assigned video camera priority level that is equal to or below the video camera priority level assigned to the user who locked the video camera, a selectable request icon 172 is presented in the video camera control panel 124 below the lock 170 as shown in FIG. 5a. If the other user selects the request icon 172, a message requesting that the user who locked the video camera release it, is displayed in the local chat panel 126. If the other user has an assigned video camera priority level that is higher than the video camera priority level assigned to the user who locked the video camera, the selectable request icon 172 as well as a selectable take over icon 174 are presented in the video camera control panel 124 below the lock 170 as shown in FIG. 5b. If the other user selects the request icon 172, the message requesting that the user who located the video camera release it, is displayed in the local chat panel 126. If the other user selects the take over icon 174, control of the video camera is automatically switched to the other user.

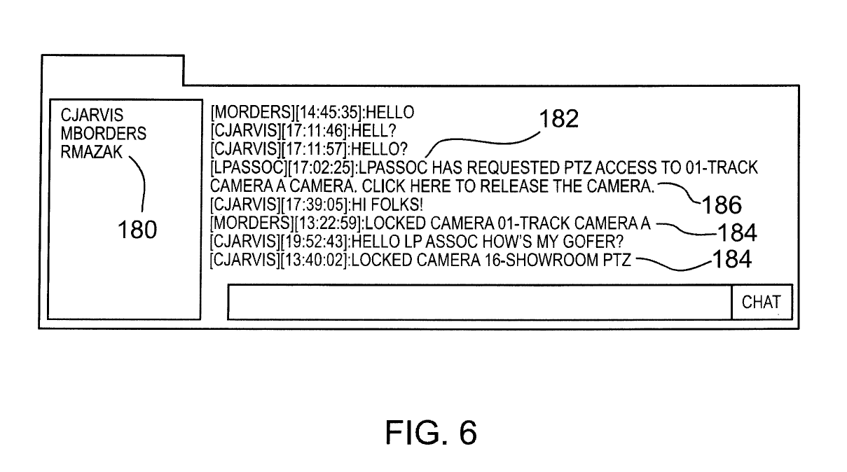

FIG. 6 better illustrates the local chat panel 126. As can be seen, the local chat panel 126 includes a list 180 all of the users that are currently logged into the enterprise management system 30 who are associated with the same facility. Messages generated by those users are also displayed. In this example, a message requesting that a video camera be released is shown at reference numeral 182. Also, messages identifying video cameras that have been locked are shown at reference numeral 184. The message 184 requesting that a locked video camera be released includes a selectable deactivate message 186.

If the user in response to the message to release the locked video camera 184 selects the selectable deactivate message 186, the locked video camera is released and a message is displayed in the local chat panel 126 notifying users of the same. Of course, rather than selecting the deactivate message 186, the user who locked the video camera can also select the priority level end button 94. Once the locked video camera has been released, the other user is able to assume control of that video camera. If the user does not wish to release the locked video camera, one of three situations may arise. If the other user has an assigned video camera priority level equal to or below the video camera priority level assigned to the user who locked the video camera, the user who locked the video camera can continue controlling the video camera. In this case, the other user who wishes to access the locked video camera must simply wait until the locked video camera has been released. If the other user has an assigned video camera priority level higher than the video camera priority level assigned to the user who locked the video camera, the other user can decide whether to assume control of the locked video camera immediately by selecting the take over icon 174 or allow the user who locked the video camera to continue controlling the video camera. In the latter case, the other user who wishes to access the locked video camera can wait until their task becomes urgent or until the locked video camera has been released. Any lock that has been assigned to a video camera by a user is immediately deactivated when the user logs out of the enterprise management web application.

As mentioned above, priority access to video cameras is typically determined by the location of users relative to the video cameras and the users' job functions. For example, on-site users of a facility typically have a higher access priority to on-site video cameras as compared to users associated with remote facilities. On-site security personnel typically have higher access priority to video cameras than other on-site users. In this manner, users whose job roles require access to video cameras are always able to assume control of video equipment in their facility.

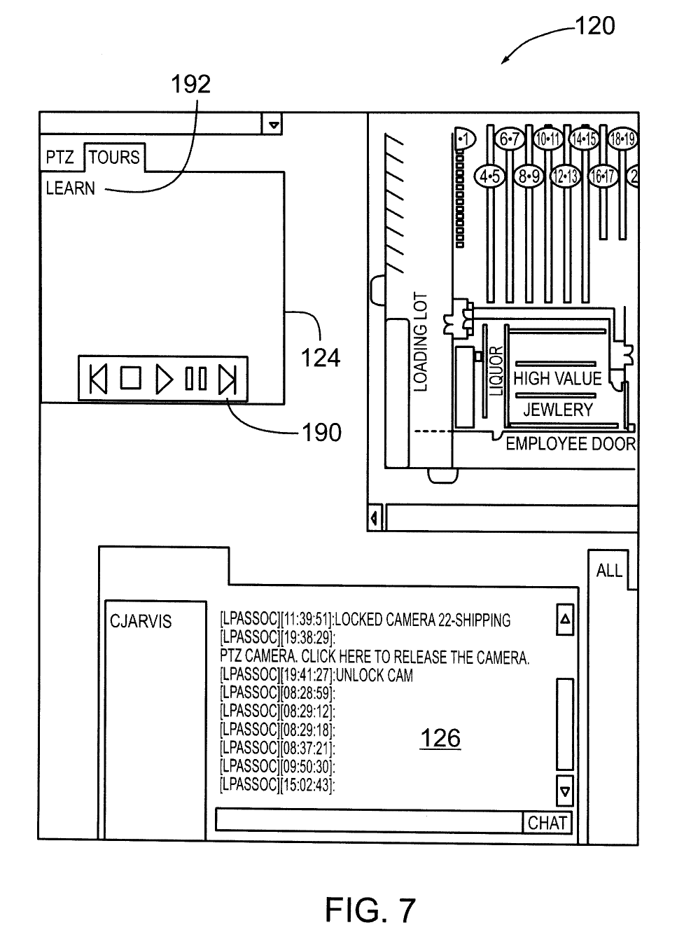

When the tours view of the video camera control panel 124 is selected, a list of available tours is presented as shown in FIG. 7. Each tour comprises a list of video cameras, and one or more views associated with each video camera in the list. The views establish the position(s) of the video cameras from which video images are to be acquired. When a tour is selected by the user, the tour runs through the list of video cameras once and in order beginning with the first video camera in the list. The tour stops at each view associated with each video camera for a set amount of time so that the video feed from the video camera in that view is presented in the video camera view panel 122. A video control bar 190 is also displayed in the video camera control panel 124 allowing the user to pause, resume, reverse, forward and stop the tour video feed. A learn icon 192 is also displayed in the video camera control panel 124 when the enterprise management system administrator or other designated individual has accessed the enterprise management web application. Selecting the learn icon 192 allows a tour to be created. If the tour involves a video camera that has been locked, the tour is stopped when the tour reaches the locked video camera and the user is presented with a selectable option that allows the tour to skip the locked video camera and continue at the next available video camera.

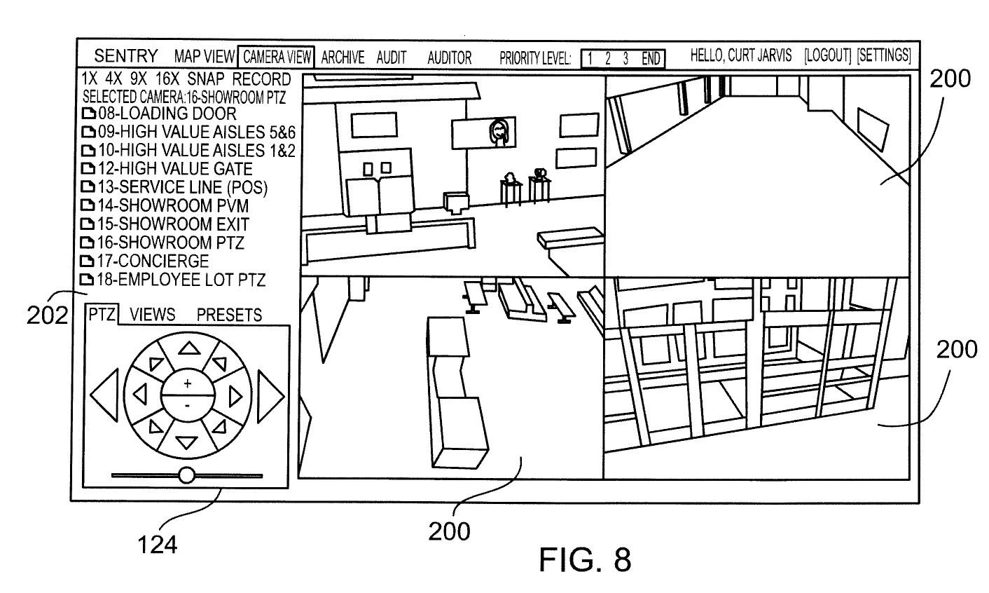

When the user selects the video camera view icon 106 from the header 80, the floor plan panel 120 is replaced with a video camera view panel 200 and the video camera view panel 122 is replaced with a list 202 of available video cameras in the selected facility as shown in FIG. 8. When a video camera is selected from the list 202, the video feed from the selected video camera is automatically presented in the video camera view panel 200. When a second video camera is selected from the list 202, the video camera view panel is automatically partitioned to present four (4) video camera view panels 200. The video feeds from the two selected video cameras are automatically presented in two of the video camera view panels 200. When third and fourth video cameras are selected from the list 202, the video feeds from these video cameras are automatically presented in the remaining two video camera view panels 200. If the user selects a fifth video camera from the list 202, the video camera view panel is automatically partitioned to present nine (9) video camera view panels 200 and the video feeds from the selected video cameras are automatically presented in five of the video camera view panels 200. When additional video cameras are selected from the list 202, the video feeds are automatically presented in the remaining video camera view panels 200. If the user selects a tenth video camera from the list 202, the video camera view panel is automatically partitioned to present sixteen (16) video camera view panels 200 and the video feeds from the selected video cameras are automatically presented in ten of the video camera view panels 200. When additional video cameras are selected from the list 202, the video feeds are automatically presented in the remaining video camera view panels 200.

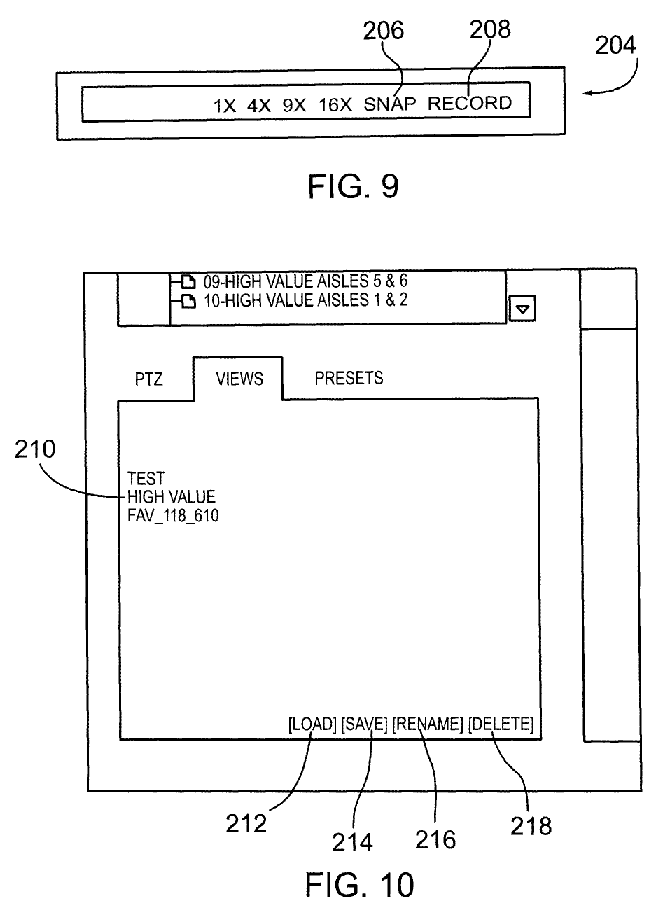

The number of video camera view panels 200 is also automatically adjusted as video cameras from the list 202 are deselected. A grid panel 204 is also presented above the list 202 to allow the user to configure the video camera view panel 200 so that it includes a single video camera view panel, four video camera view panels, nine video camera view panels or sixteen video camera view panels as shown in FIG. 9.

When a video camera view panel 200 is selected, the selected video camera view panel is highlighted and snap and record icons 206 and 208 respectively, in the grid panel 204 are enabled. If the user selects the snap icon 206, a snap shot of the current video feed presented in the selected video camera view panel 200 is acquired and is saved in a folder associated with the user. If the user selects the record icon 208, a movie clip of the video feed presented in the selected video camera view panel 200 is acquired and is saved in the folder associated with the user. If the video camera associated with the selected video camera view panel 200 is a PTZ video camera or a moving track video camera, the video camera control panel 124 is enabled and the default view of FIG. 4 is presented allowing the video camera to be controlled by the user in the manner described above.

In the video camera view, the video camera control panel 124 also includes a views tab and a presets tab. When the views tab is selected, a list 210 of presets for the video camera associated with the selected video camera view panel 200 that have been saved by the user is presented together with a selectable load button 212, a selectable save button 214, a selectable rename button 216 and a selectable delete button 218 as shown in FIG. 10. When a video camera preset view from the list 210 is highlighted and the load button 212 is selected, the video feed from the video camera in that preset view is presented in the highlighted video camera view panel 200. Highlighted video camera preset views can be deleted from the list 210 by selecting the delete button 218 or renamed by selecting the rename button 216. A video camera preset view can be added to the list by using the video camera control panel 124 to position the video camera in the desired location and then selecting the save button 214.

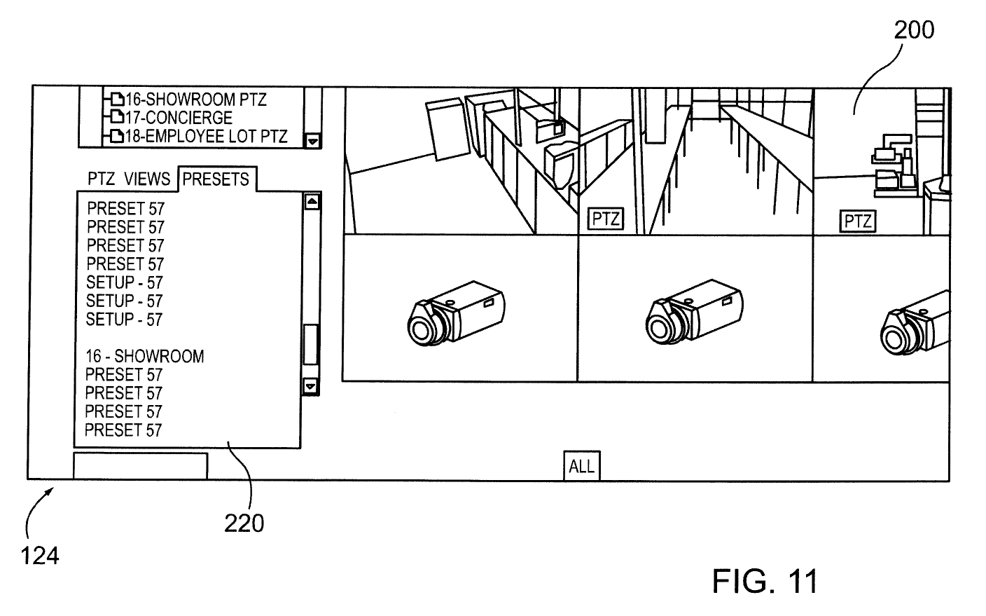

When the presets tab is selected, a list 220 of all previously saved presets for each selected video camera in the target facility whose video feed is being presented in a video camera view panel 200, is presented in the video camera control panel 124 as shown in FIG. 11. The presets in the list 220 are organized by video camera. If a preset is selected from the list 220, the video camera associated with the selected preset is automatically positioned according to the preset.

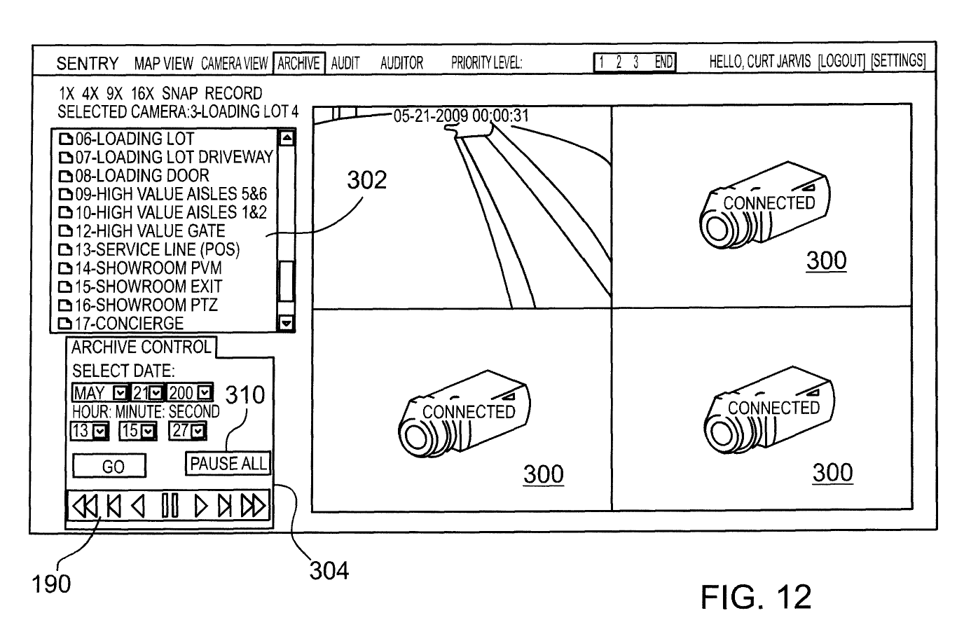

When the user selects the archive view icon 108 from the header 80, a video camera view panel 300, a list 302 of available video cameras and an archive control panel 304, are displayed as shown in FIG. 12. The archive control panel 304 allows the user to specify the start date and time from which previously recorded video data is to be replayed. When a video camera is selected from the list 302 and the start date and time of previously recorded video has been entered into the archive control panel 304 by the user, pre-recorded video is automatically presented in the video camera view panel 304. When a second video camera is selected from the list 302, the video camera view panel 304 is automatically partitioned to present four (4) video camera view panels 300. Pre-recorded video from the two selected video cameras are automatically presented in two of the video camera view panels 300. When third and fourth video cameras are selected from the list 302, pre-recorded video from these video cameras are automatically presented in the remaining two video camera view panels 300. If the user selects a fifth video camera from the list 302, the video camera view panel 304 is automatically partitioned to present nine (9) video camera view panels 300 and pre-recorded video from the selected video cameras are automatically presented in five of the video camera view panels 300. When additional video cameras are selected from the list 302, pre-recorded video is automatically presented in the remaining video camera view panels 300. If the user selects a tenth video camera from the list, the video camera view panel 304 is automatically partitioned to present sixteen (16) video camera view panels and pre-recorded video from the selected video cameras is automatically presented in ten of the video camera view panels 300. When additional video cameras are selected from the list pre-recorded video is automatically presented in the remaining video camera view panels 300.

The number of video camera view panels 300 is also automatically adjusted as video cameras from the list 302 are deselected. The grid panel 204 is also presented above the video camera list 302 to allow the user to configure the size of the video camera view panel grid in the same manner described above.

When a video camera view panel 300 from the grid is selected, the selected video camera view panel is highlighted and the snap and record icons 206 and 208, respectively, in the grid panel 204 are enabled. If the user selects the snap icon 206, a snap shot of the pre-recorded video presented in the selected video camera view panel 300 is saved in a folder associated with the user. If the user selects the record icon 208, a movie clip of the pre-recorded video presented in the selected video camera view panel 300 is saved in the folder associated with the user. The video control bar 190 is also displayed in the video camera control panel 124 allowing the user to pause, resume, reverse, forward and stop the pre-recorded video presented in the selected video camera view panel 300. A selectable pause all button 310 allows the pre-recorded video being shown in each of the video camera view panels 300 to be paused simultaneously.

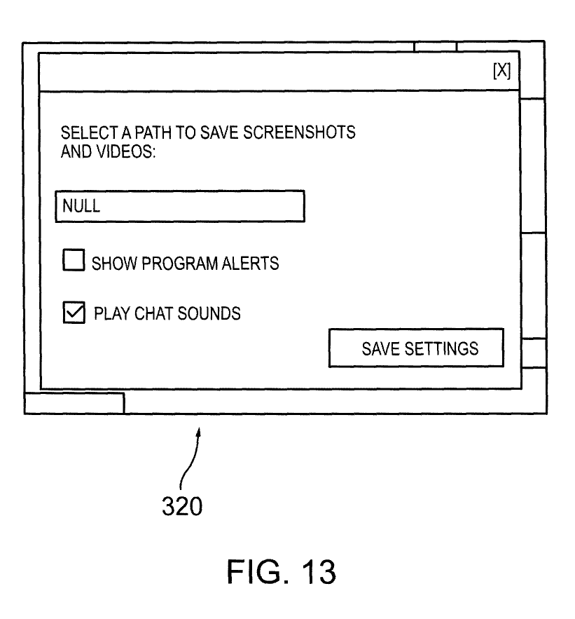

When the user settings button 114 is selected, a window 320 is opened that allows the user to specify the folder location in which saved snapshots and movie clips are to be saved as shown in FIG. 13. The window 320 also allows the user to enable program and chat alerts.

When the user has logged into the enterprise management web application via a client 38 in the form of a personal computer or laptop computer, controlling of the cameras is typically performed from a stationary location. However, when the user has logged into the enterprise management web application via a client 38 in the form of a handheld device, a user walking through the facility in which the CCTV system under control is located, is able to review and manage video feeds. Also, the user is able to receive messages from other users such as security personnel thereby to enhance the ability to apprehend shoplifters.

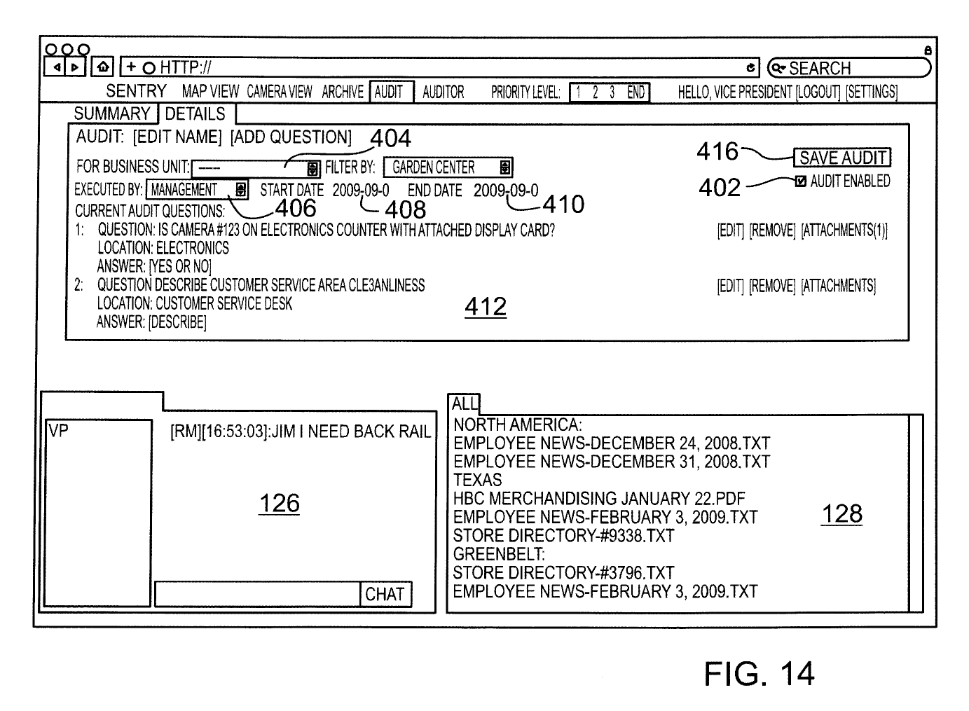

The enterprise management system 30 also permits designated users, such as for example, business unit managers, external clients etc. to create and submit audit requests via an audit request view web page. FIG. 14 shows an exemplary audit request view web page presented beneath the header 80 when the audit button 90 is selected. As can be seen, the audit request view web page includes an audit enabled field 402 and a field 404 that allows the target facility in which the audit is to be performed to be identified. The audit request view web page also includes fields 406, 408 and 410 that allow the group of users who is to perform the audit, the date on which the audit may be commenced and the end date by which the audit must be completed to be specified. The audit request view web page also comprises an audit question panel 412 in which new audit questions may be entered, and existing audit questions modified or deleted. The audit question panel 412 also permits one or more media files such as pictures or videos to be attached to each of the audit questions listed in the panel. The media files are typically used as reference data against which to compare live video when answering the audit questions. The media files may be downloaded from a remote location, downloaded from a digital camera or other image capture device or received from a handheld device of a user logged into the enterprise management web application. An audit save button 416 allows the data associated with the audit request view web page to be stored in the web server database.

When the audit enabled field 402 is selected, and when the audit save button 416 has been selected, the enterprise application control module 62 invokes the audit application 78 running on the web server 34. The web server 34 examines the data associated with the saved audit request view web page to determine the target facility associated with the audit request and the identified group of users who is to perform the audit. The audit application then automatically aggregates submitted audit requests with existing audit requests to create an audit and assigns the created audit to the identified group of users who is to perform the audit. In this manner, audit requests created by different users relating to a common facility and specifying the same identified group of users who is to perform the audit are bundled into a single audit if their specified start and completion dates permit. The audits generated by the audit application are then placed in a queue.

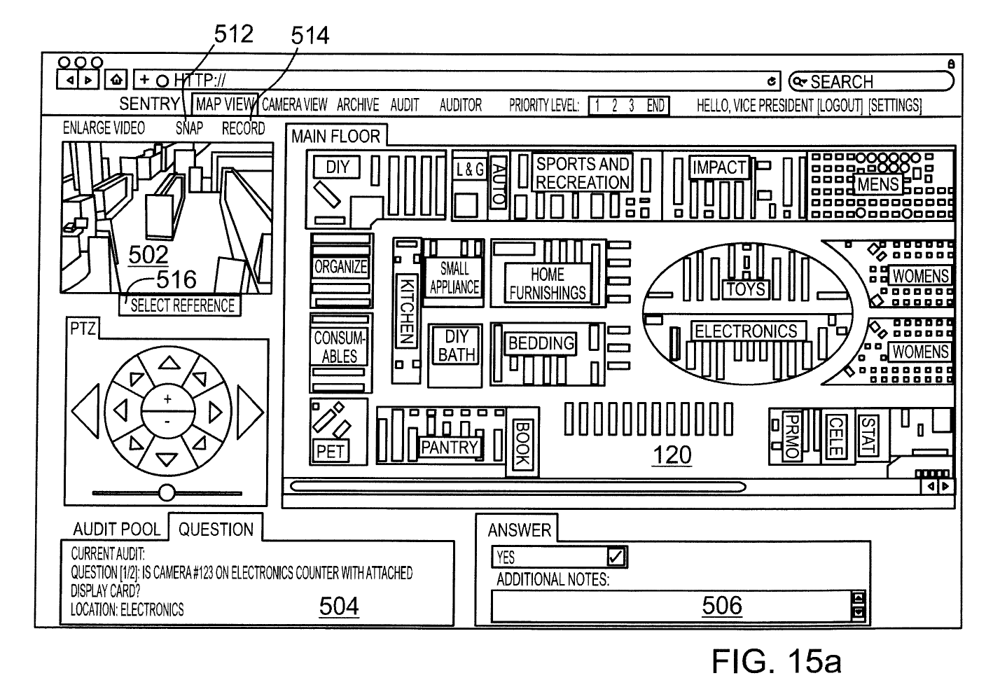

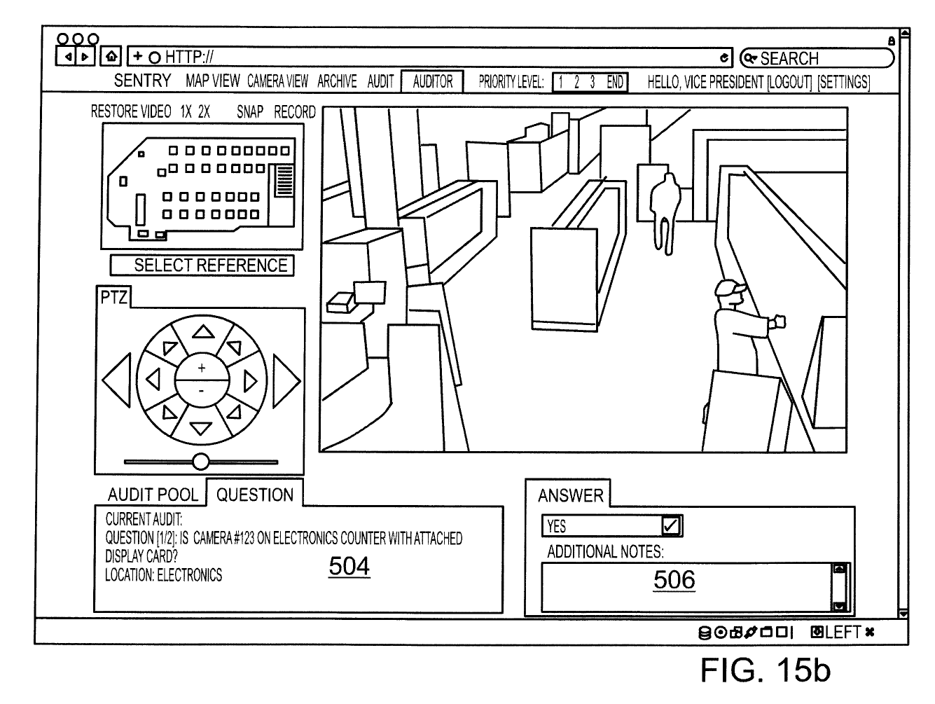

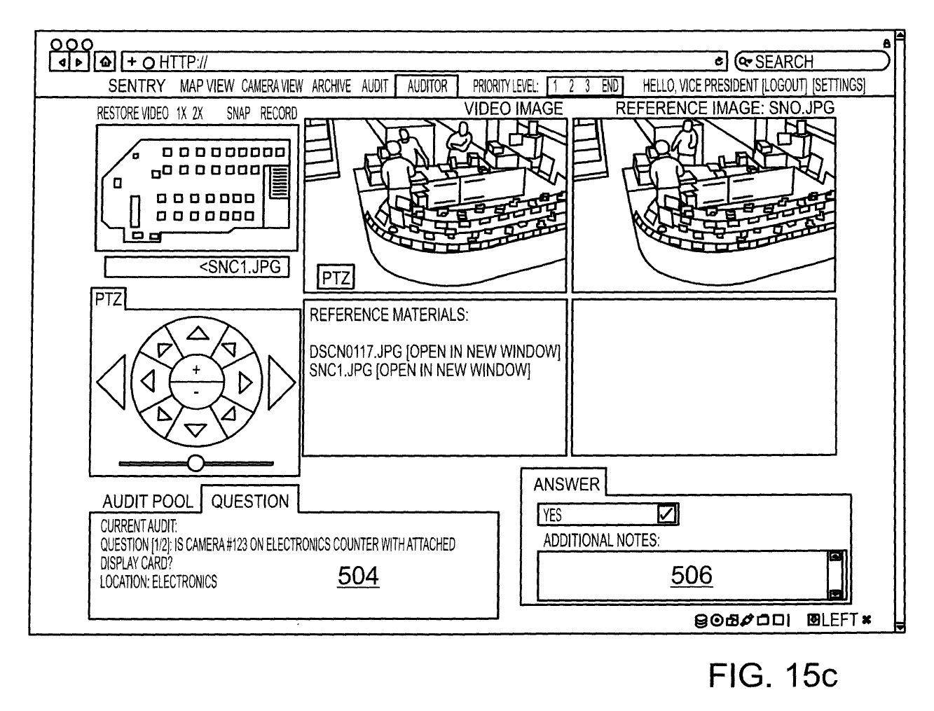

As mentioned previously, auditors are typically only permitted to control video equipment of the CCTV system at certain times and are given time frames by which to complete audits. In this manner, video camera resource conflicts between auditors and other users are reduced. When a user of an identified group of users who is to perform an audit accesses the enterprise management web application during a permitted time and selects the auditor button 92, the user is presented with an audit view web page comprising a reference image panel 502, the floor plan panel 120, the video camera control panel 124, an audit pool/question panel 504, and an answer and note panel 506 as shown in FIG. 15a. The reference image panel 502 presents a selected media file, if one or more exist, associated with the audit question that is currently presented in the audit pool/question panel 504 and has associated enlarge video, snap and record buttons 510, 512 and 514 as well as a select reference bar 516. If more than one media file is associated with the current audit question, selecting the select reference bar 516 allows the desired media file to be selected for presentation in the reference image panel 502. As mentioned above and as illustrated, the floor plan panel 120 shows a layout or floor plan of the selected facility and has selectable “hotspots” 140 representing the various video cameras within the facility. When a hotspot 140 is selected, the video camera associated with the selected hotspot is automatically activated and moved to a preset view. The floor plan panel 120 is then replaced with the video camera view panel 122 and the video feed of that video camera is presented in the video camera view panel 122 as shown in FIG. 15b. The answer and note panel 506 allows the user to answer each audit question typically by comparing the live video feed in the video camera view panel 122 with one or more of the reference media files, if they exist.

If the enlarge video button 510 is selected, the video camera view panel 122 is partitioned into multiple video camera view panels. The live video feed from the video camera is presented in one of the video camera view panels and the reference image is presented in an adjacent video camera view panel allowing a side-by-side comparison of the displayed images to be made as shown in FIG. 15c.

During examination of the live video feeds, the user can capture snapshots and/or movie clips of the live video feeds in the same manner described above by selecting the snap and/or record buttons 512 and 514. Captured snapshots and/or movie clips can be saved in an audit folder in the web server database. Typically, the audit questions may request the user to indicate whether the live video feed when compared to the reference media file(s) represents a pass or fail. Alternatively, the audit questions may request the user to indicate the percentage degree to which the live video feed resembles the reference media file(s). Still alternatively, the audit questions may request the video auditor to select a statement from a list that best represents the result of the comparison between the live video feed and the reference media file(s). Of course, the audit questions may comprise a combination of the above tasks or different tasks altogether. The user who submitted the audit request is able to access the audit folder at any time to determine the status of the audit request. In some instances, if desired, rather than using the CCTV system feeds, images captured at one or more locations using handheld devices can be transmitted to the enterprise web management application and used for audit purposes.

Once an audit has been completed, the users who submitted audit requests forming part of the audit are notified. The answers to the audit questions, and any snapshots and/or movie clips captured by the user that are associated with the audit request can be downloaded from the web server database by the user who submitted the audit request for further processing in a spreadsheet or other predefined reporting format. In situations where the results of an audit request signify a fail, the audit application generates an exception report that is sent to an executive of the retail enterprise for remedial action.

As will be appreciated, the users carrying out the audit requests can be employees of the retail enterprise, third party users that have been subcontracted to carry out the audits, or clients of the retail enterprise. In the case of retail establishments, product displays are extremely important. Product suppliers who pay for product positioning in aisles and on aisle end caps and who develop promotional material to accompany product want to ensure that their products and promotional material are properly displayed. Product suppliers have in the past typically hired third party auditors, whose role is to visit the various facilities in which their products are being sold to ensure the products and promotional material are properly displayed. Performing audits in this manner is very difficult and expensive especially during product launches that occur in numerous different geographical locations simultaneously. The audit application described above allows product displays to be examined remotely using CCTV systems thereby avoiding the expense associated with having individuals visit facilities to conduct audits on-site. In situations where audits are being carried out by external users, the access time to the enterprise management application can be sold to the external users. The fact that audits are random and electronic ensures a more accurate representation of business unit activities as compared with traditional physical site visits which are often predictable by employees.

The task application of the enterprise management web application allows specified users to post tasks that are to be completed by specific individuals within the retail enterprise. For example, head office merchandising managers often need to convey the latest in store display information to hundreds and in some cases thousands of retail locations. When a task is posted, documents such as for example, text, image and/or multimedia files associated with the task are saved to the web server database and the specific individuals designated to complete the tasks are notified allowing the specified individuals to access the associated task documents. Once the task has been completed by a specified user, the specified user can send an acknowledgement. The completed task can then be audited as described above. Audits can be run on an exception basis identifying the facilities that failed to complete the task to the desired standard so that immediate corrective action can be taken.

Large enterprises are also faced with the challenge of keeping all employees current with changing company policies and procedures and in particular training new employees. The enterprise management web application allows users to training materials in the form of media files etc. to be posted to the database for viewing by specified users. The specified users can create training sessions using the posted training material and designate the users who are required to participate in the training sessions. When a designated user completes the training session, the designated user can send an acknowledgement allowing a report to be generated which identifies the designated users that have and have not completed the requisite training.

In the example described above, audits are preformed manually by auditors who have accessed the enterprise management web application during permitted times. Depending on the nature of the reference media and the audit requests forming the audits, those of skill in the art will appreciate that the audit may be performed automatically using feature recognition software running on the web server. In this case, the reference media and the video feed from each selected video camera are processed by the feature recognition software and compared to determine whether the video feed represents a compliant display. Alternatively, the audit may be performed semi-automatically.

Also, in the example described above, the exemplary enterprise is described as a retail enterprise. Those of skill in the art will however appreciate that the enterprise may be of basically any type. The enterprise management web application may be embodied on a computer readable medium. The computer readable medium is any data storage device that can store data, which can thereafter be read by a computer system. Examples of computer readable medium include for example read-only memory, random-access memory, CD-ROMs, magnetic tape and optical data storage devices.

Although specific reference is made to an enterprise management system employing CCTV systems, those of skill in the art will appreciate that the enterprise management system may employ other types of camera-based or video surveillance systems or a combination of CCTV systems and other video surveillance systems.

Although embodiments have been described above with reference to the accompanying drawings, those of skill in the art will appreciate that variations and modifications may be made without departing from the spirit and scope thereof as defined by the appended claims.

1. An auditing method comprising:
controlling at least one camera device at least at one facility to cause the at least one camera to acquire at least one image of a designated region within the at least one facility;
at a remote location, comparing the acquired at least one image of the designated region to a desired standard; and
completing an audit report based on the results of the comparing.

2. The method of claim 1 wherein during said comparing, the at least one image is compared to at least one reference image.

3. The method of claim 2 wherein the at least one reference image represents the desired appearance of a product display.

4. The method of claim 3 wherein the at least one reference image is created by a supplier of the product.

5. The method of claim 4 wherein the controlling, comparing and completing is performed by an auditor at arms length to said facility.

6. The method of claim 5 wherein said facility is one of a number of facilities within an enterprise and wherein said auditor is a member of said enterprise.

7. The method of claim 5 wherein said facility is one of a number of facilities within an enterprise and wherein said auditor is an individual external to said enterprise.

8. The method of claim 7 wherein said individual is associated with a supplier of the displayed product.

9. The method of claim 7 wherein said individual is contracted by the supplier of the displayed product.

10. The method of claim 3 wherein said completing comprises completing an electronic questionnaire.

11. The method of claim 10 wherein said electronic questionnaire comprises one or more of a pass/fail indicator, an indication of the percentage degree to which the acquired at least one image resembles the at least one reference image and a statement from a list that best represents the result of the comparing.

12. The method of claim 2, wherein said at least one camera device forms part of a video surveillance system and wherein said controlling is only permitted during designated times.

13. The method of claim 12 further comprising setting a data by when the audit report must be completed.

14. The method of claim 12 wherein said comparing comprises visually comparing the at least one image and the at least one reference image.

15. The method of claim 12 wherein said comparing is one of (i) performed at least partially by feature recognition software and (ii) performed fully by feature recognition software.

16. The method of claim 12 wherein said video surveillance system is a closed-circuit television (CCTV) system.

17. The method of claim 1 wherein said at least one camera device is controlled via a client device.

18. The method of claim 17 wherein said client device is one of a stationary computing device, a portable computing device and a handheld computing device.

19. The method of claim 1 wherein said controlling further comprises adjusting the zoom and/or position of the at least one camera device.

20. An auditing method comprising:
receiving electronic audit requests from internal and/or external users of a multi-facility enterprise;
aggregating audit requests that relate to common facilities into individual audits;
assigning electronically each of said audits to one or more individuals of an audit group specified for said audit; and
assigning viewing access rights to the one or more individuals of the audit group, the viewing access rights determining when the one or more individuals are able to access video feeds from camera devices in the facilities to complete the audits.

21. The method of claim 20 wherein the viewing access rights determine the time of day that the one or more individuals are able to access video feeds.

22. The method of claim 21 wherein the viewing access rights further determine when audits must be completed.

23. The method of claim 20 wherein viewing access rights to video surveillance systems at a plurality of different geographical locations are assigned.

24. An auditing method comprising:
using a video surveillance system at one or more facilities to capture images of one or more product displays; and
comparing the captured images with reference material to evaluate product display compliance.

25. The method of claim 24 further comprising:
controlling usage of the video surveillance system to inhibit resource request conflicts between users.

26. The method of claim 24 wherein said using and performing is performed by auditors at arms length to said facilities.

27. The method of claim 24 wherein said using is carried out over an Internet connection.

28. The method of claim 24 wherein said comparing comprises completing an audit report.

29. The method of claim 28 wherein said audit report is an electronic questionnaire.

30. The method of claim 29 wherein said electronic questionnaire comprises one or more of a pass/fail indicator, an indication of the percentage degree to which the acquired at least one image resembles the at least one reference image and a statement from a list that best represents the result of the comparing.

31. The method of claim 28 further comprising setting a date by when the audit report must be completed.

32. The method of claim 24 wherein said using further comprises adjusting the zoom and/or position of one or more camera devices of said video surveillance system.

33. The method of claim 24 wherein said comparing is one of (i) performed manually, (ii) performed at least partially by feature recognition software and (iii) performed fully by feature recognition software.

34. An apparatus configured to establish communications between at least one client and a video surveillance system at one or more facilities, said apparatus further configured to signal a video surveillance system to capture images of one or more product displays and provide the captured images to the at least one client for comparison with reference material to evaluate product display compliance.

35. The apparatus of claim 34 wherein said client device is one of a stationary computing device, a portable computing device and a handheld computing device.

36. The apparatus of claim 34 wherein said apparatus is further configured to adjust the zoom and/or position of one or more camera devices of said video surveillance system.

37. The apparatus of claim 34 wherein said video surveillance is a closed-circuit television (CCTV) system.

38. A method comprising:
providing multiple users with access to at least one surveillance system at one or more facilities to allow said users to view video captured by the at least one surveillance system and to control video equipment thereof; and
controlling access of said users so that users performing priority tasks are given access to the at least one surveillance system over other users.

39. The method of claim 38 wherein said access controlling comprises giving access to users performing security tasks over users performing other tasks.

40. The method of claim 39 wherein said other tasks comprise product display audits and training.

41. An apparatus configured to establish communications between a plurality of clients and at least one surveillance system at one or more target facilities to enable clients performing tasks to view video and control video equipment of said at least one surveillance system, said apparatus being further configured to assign priority rights thereby to ensure clients performing higher priority tasks have preference over clients performing lower priority tasks.

42. The apparatus of claim 41 wherein said lower priority tasks comprise video audits and wherein said higher priority tasks comprise security tasks.

43. A non-transitory computer readable medium embodying a computer program, said computer program comprising:
program code for causing a camera device of a video surveillance system to capture one or more images of a product display; and
program code for comparing each captured image with reference material to evaluate product display compliance.

44. A video surveillance controller configured to:
allow cameras linked to user access rights to be selected;
represent the locations of the cameras on a displayed floor plan map, areas of the floor plan being linked to preprogrammed camera views; and
provide access to camera views in response to selection of the camera representations on the floor map.
